(19) United States
(12) Patent Application Publication
(10) Pub. No.: US 2008/0037361 A1
(43) Pub. Date: Feb. 14, 2008

(54) Mixer apparatus

(76) Inventors: Jerry Fleishman, Holland, MI (US); George McIntosh, Holland, MI (US); Tom Post, Pittsford, NY (US); Zachary Miller, New Era, MI (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/706,475

(22) Filed: Feb. 15, 2007

Related U.S. Application Data
(60) Provisional application No. 60/773,496, filed on Feb. 15, 2006.

(51) Int. Cl. B01F 15/02

(52) U.S. Cl. 366/131

(57) ABSTRACT

A mixer apparatus comprising a mixing chamber assembly, a mixing agitation assembly and an orifice assembly. The mixing chamber assembly includes a housing defining a cavity, an inlet providing fluid communication with the cavity and an outlet providing fluid communication with the cavity. The mixing agitation assembly includes a motor assembly, a drive shaft coupled to the motor assembly and at least one impeller coupled to the drive shaft. The at least one impeller and at least a portion of the drive shaft are positioned within the housing and are also positioned between the inlet and the outlet. The orifice assembly includes at least one orifice positioned between the inlet and the at least one impeller. Upon direction of a working fluid into the cavity through the inlet and through the at least one orifice, at least a portion of the fluid is mixed by the impeller and exhausted through the outlet.

### BACKGROUND OF THE INVENTION

This application claims priority from U.S. Provisional Patent Application Ser. No. 60/773,496 filed Feb. 15, 2006, the entire specification of which is hereby incorporated by reference in its entirety.

1. Field of the Invention

The present invention relates in general to mixers, and more particularly to a mixer apparatus for use in association with, for example, mixing of solids with a working fluid. For example, the mixer apparatus of the present invention discloses pumper impellers which are well suited for the mixing of oil well drilling mud and the like as the mixer both mixes and shears the material. The invention, however, is not limited to the mixing of solids with a working fluid, or limited to use in association with the oil drilling industry. It is contemplated that the mixer apparatus of the present invention is well suited for a number of different applications.

2. Background Art

Many industrial processes and other methods require the combining or mixing of various materials together, such as, for example, solids within a working fluid. Typically, with many such applications, as the dispersion of the solids within the working fluid increases, the resulting mixture exhibits improved performance. There is often a struggle properly mix various materials together. Difficulty is likewise encountered relative to the maintenance of solids within a mixture.

By way of example, the oil drilling industry typically uses what is commonly referred to as “mud” which is a mixture of a number of solids with a working fluid. Generally, the solids are introduced into a stream of water or other working fluid (such as diesel fuel) through any number of different methods. Once introduced, the solids and the working fluid mix to some extent as they are directed to a holding tank. In certain applications, the tank may include recirculation pumps which re-circulate the mixture so as to limit separation.

While such mixing systems have been employed for many years with some success, there are nevertheless drawbacks to such systems. In particular, solids are often not well dispersed within the working fluid. As such, it is generally necessary to continuously agitate the mixture to preclude undesirable separation thereof. Second, such a mixture often lacks the desired viscosity which leads to poor or reduced performance during use in the well drilling operation. Typically, the result is increased wear and maintenance to equipment coupled with an increased operating cost. Third, increased quantities of solids may be required to achieve a desired performance in a inadequately mixed material. In addition to the cost of materials, certain drilling operations are in remote locations place a premium on storage and inventory space.

Accordingly, it is an object of the present invention to provide a mixer apparatus which can disperse a solid within a working fluid.

It is another object of the present invention to provide for a more uniform mixture of solids with a working fluid.

It is another object of the present invention to improve the mixture of solids within a fluid.

It is another object of the present invention to improve the performance of mud used in association with oil drilling, while the invention is not limited to such use.

Additional objects will be understood with reference to the drawings and claims appended hereto.

### SUMMARY OF THE INVENTION

The invention is directed to a mixer apparatus which overcomes the shortcomings of the prior art. In particular, such a mixer comprises a mixing chamber assembly, a mixing agitation assembly and an orifice assembly. The mixing chamber assembly comprises a housing defining a cavity, an inlet providing fluid communication with the cavity and an outlet providing fluid communication with the cavity. The mixing agitation assembly comprise a motor assembly, a drive shaft coupled to the motor assembly and at least one impeller coupled to the drive shaft. The at least one impeller and at least a portion of the drive shaft are positioned within the housing and are also positioned between the inlet and the outlet. The orifice assembly includes at least one orifice positioned between the inlet and the at least one impeller. As fluid is directed into the cavity through the inlet and through the at least one orifice, at least a portion of the fluid is mixed by the impeller and exhausted through the outlet.

In a preferred embodiment, the outlet is positioned above the inlet such that fluid directed through the inlet extends in a generally vertically upward direction as it progresses from the inlet, through the at least one orifice, the at least one impeller and the outlet.

In another preferred embodiment, the orifice assembly further comprises a first orifice and a second orifice in a spaced apart configuration within the housing so as to define a first region between the second orifice and the housing and a second region between the first and second orifices. The at least one impeller comprises a first impeller positioned in the first region and a second impeller positioned in the second region.

In another preferred embodiment, the orifice assembly further comprises a frame coupled to each of the first orifice and the second orifice. The frame is removably positionable within the cavity so as to facilitate the positioning of the first and second orifice in a proper special orientation.

In one such embodiment, the second orifice is spaced apart from the housing so as to define a third region between the housing and second orifice, opposite the second region.

In one such embodiment, the inlet is directed into the third region of the cavity. In another such embodiment, the first and second regions are substantially identical in volume.

In a preferred embodiment, the at least one orifice is substantially circular.

In another embodiment, the at least one orifice is spaced apart from the at least one impeller.

In a preferred embodiment, the drive shaft rotates about an axis that is parallel to the flow of fluid through the mixer.

In yet another aspect of the invention, the invention is directed to a method of mixing mud suitable for use in oil well drilling applications. The method comprises the steps of: providing the mud through an inlet; directing the mud through an orifice; mixing the mud with an impeller; directing the mud through a second orifice; mixing the mud with a second impeller; and directing the mud through an outlet.

### BRIEF DESCRIPTION OF THE DRAWINGS

The invention will now be described with reference to the drawings wherein:

FIG. 1 of the drawings comprises a cross-sectional view of the mixer apparatus of the present invention;

FIG. 2 of the drawings comprises a partially exploded partial perspective view of the mixer apparatus of the present invention, showing in particular the mixing chamber assembly and the orifice assembly;

FIG. 3 of the drawings comprises a top plan view of the mixing chamber assembly and the orifice assembly of the mixer apparatus of the present invention;

FIG. 4 of the drawings comprises a partial cross-sectional view of the mixer apparatus of the present invention, showing in particular, the placement of the drive shaft, the impellers and the orifices within the mixing chamber assembly;

FIG. 5 of the drawings comprises a cross-sectional view of an alternate mixing chamber assembly;

FIG. 6 of the drawings comprises a perspective view of another alternate mixing chamber assembly; and

FIG. 7 of the drawings comprises a cross-sectional view of the mixer apparatus of the present invention, showing, in particular a pallet associated therewith.

### DETAILED DESCRIPTION OF THE INVENTION

While this invention is susceptible of embodiment in many different forms, there is shown in the drawings specific embodiments with the understanding that the present disclosure is to be considered as an exemplification of the principles of the invention and is not intended to limit the invention to the embodiments illustrated.

It will be understood that like or analogous elements and/or components, referred to herein, are identified throughout the drawings by like reference characters. In addition, it will be understood that the drawings are merely representations of the present invention, and some of the components may have been distorted from actual scale for purposes of pictorial clarity.

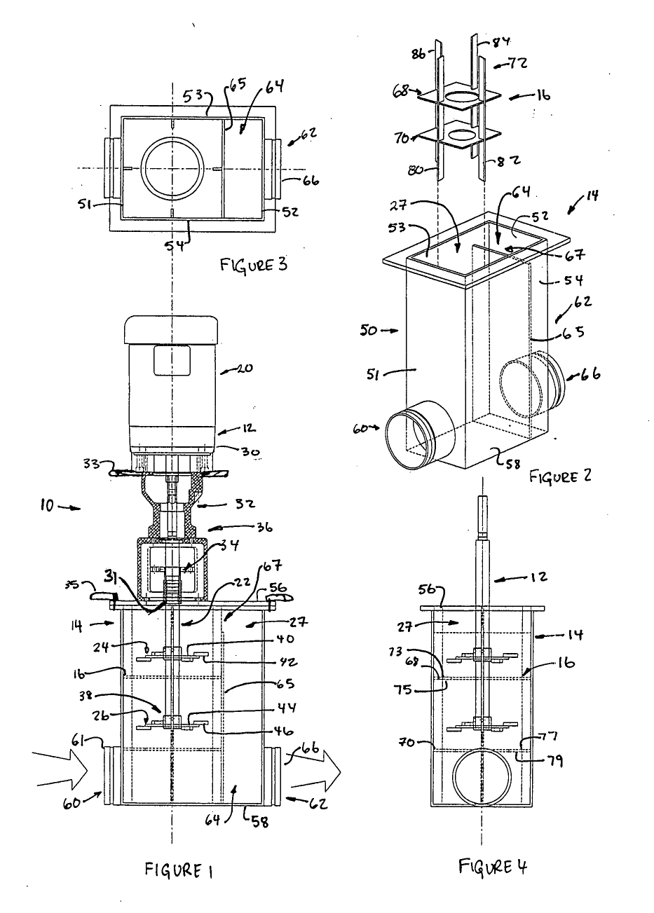

Referring now to the Figures, and in particular to FIG. 1, mixer apparatus is shown generally at 10. The mixer apparatus includes mixing agitation assembly 12, mixing chamber assembly 14 and orifice assembly 16. While not limited thereto, the mixer apparatus is contemplated for use in association with the mixing of mud used in association with oil well drilling. The mixer apparatus may be used in association with the mixing of other materials for other applications, and is certainly not limited to such use.

Mixing agitation assembly 12 is shown in FIG. 1 as comprising motor assembly 20, drive shaft 22, first impeller 24 and second impeller 26. The motor assembly 20 comprises a motor 30, clutch 32, a plurality of couplings, such as coupling 34, and shaft seal 31. The motor typically comprises any one of an electric motor, a pneumatic motor, a hydraulic motor, an internal combustion engine (without being limited thereto) which is capable of providing the power necessary to rotate the impellers at a desired speed. In the embodiment shown, the motor, the clutch and the couplings are positioned above mixing chamber 14. To enhance portability, it is contemplated that motor assembly 20 may be connected to the mixing chamber such that it can easily be separated from the mixing chamber. In one embodiment, the mixing assembly may include handles, such as handles 33 which facilitate the lifting and transport of the motor assembly.

Drive shaft 22 includes first end 36 and second end 38. The first end is coupled to motor 30. The second end of drive shaft 22 extends into mixing chamber 14. First impeller 24 is shown as comprising a bar-turbine type of impeller which includes disk 40 and blades, such as blades 42. The impeller is coupled to the drive shaft spaced apart from the second end of the drive shaft. The particular configuration of the disk and the blades can be varied depending on the particular material that is to be mixed. In the present embodiment, six blades are spaced apart form each other uniformly equally about the disk, three on one side of the disk and three on the other side of the disk. Generally the blades comprise an elongated member having a substantially square cross-sectional configuration. In other embodiments, there may be fewer (such as three, for example) blades, whereas in other embodiments there may be greater blades (for example twelve blades). The blades may or may not extend beyond the circumference of the disc. Of course, the invention is not limited to any particular construction or configuration of the disk or the blades of the impeller. In certain embodiments, the size of the disk may be minimized and the blades may be provided with varying configurations. Of course, other impeller types, including, but not limited to disperser blades, axial blades and radial blades.

Second impeller 26 is shown in FIG. 1 as comprising disk 44 and blades 46. The second impeller is positioned closer to second end 38 of drive shaft 22. In the embodiment shown, the second impeller is positioned at the second end of the drive shaft. The second impeller has a configuration which substantially matches that of the first impeller.

In the embodiment shown, the two impellers are substantially identical and the disks of the impellers are parallel to each other. In other embodiments, one impeller disc can be offset at an angle such that, upon rotation the disc appears to wobble. Additionally, while the two impellers are shown to be substantially equally spaced along the drive shaft, it is contemplated that the impellers may be positioned at substantially different positions relative to each other. Furthermore, it is contemplated that a single impeller may be utilized or a number of impellers greater than three can be employed.

Mixing chamber assembly 14 is shown in FIG. 2 as comprising housing 50, inlet 60 and outlet 62. Housing 50 generally comprises a rectangular cubic (box-like) member that includes opposing end walls 51, 52, opposing side walls 53, 54, top wall 56 (FIG. 1) and bottom wall 58. The walls define cavity 27. In the embodiment shown, the height of the chamber is greater than either the width or the depth, and the housing has a substantially uniform cross-section. The housing typically comprises a steel member, however, the use of other materials is likewise contemplated. Top wall 56 is separable from the remainder of the housing so as to provide ingress to the cavity. In the embodiment shown, each of the opposing side walls and the opposing end walls include a flange which can be coupled to the top wall with fasteners and the like. In certain embodiments, handles, such as handle 35, may be coupled to the housing with the same fasteners, so as to provide a means by which the housing can be handled.

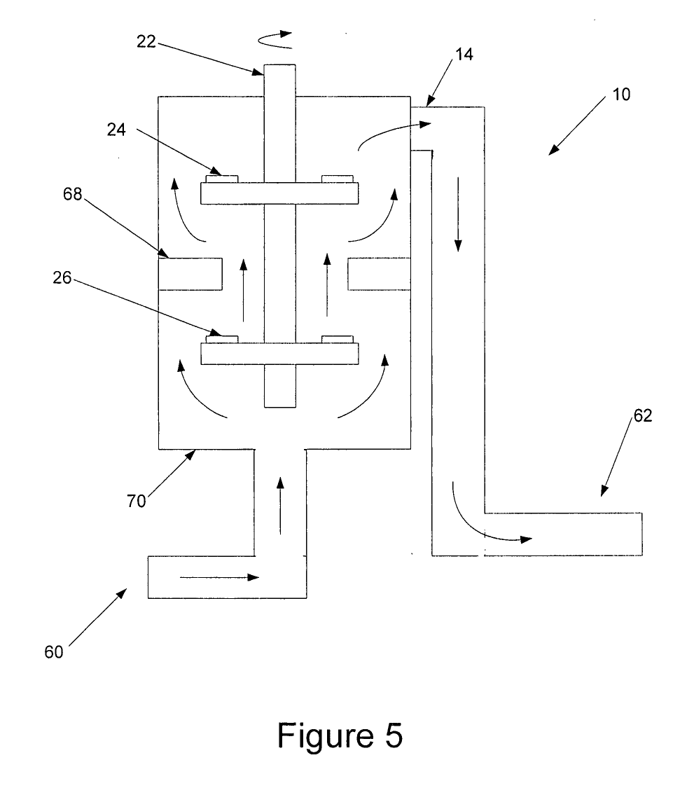

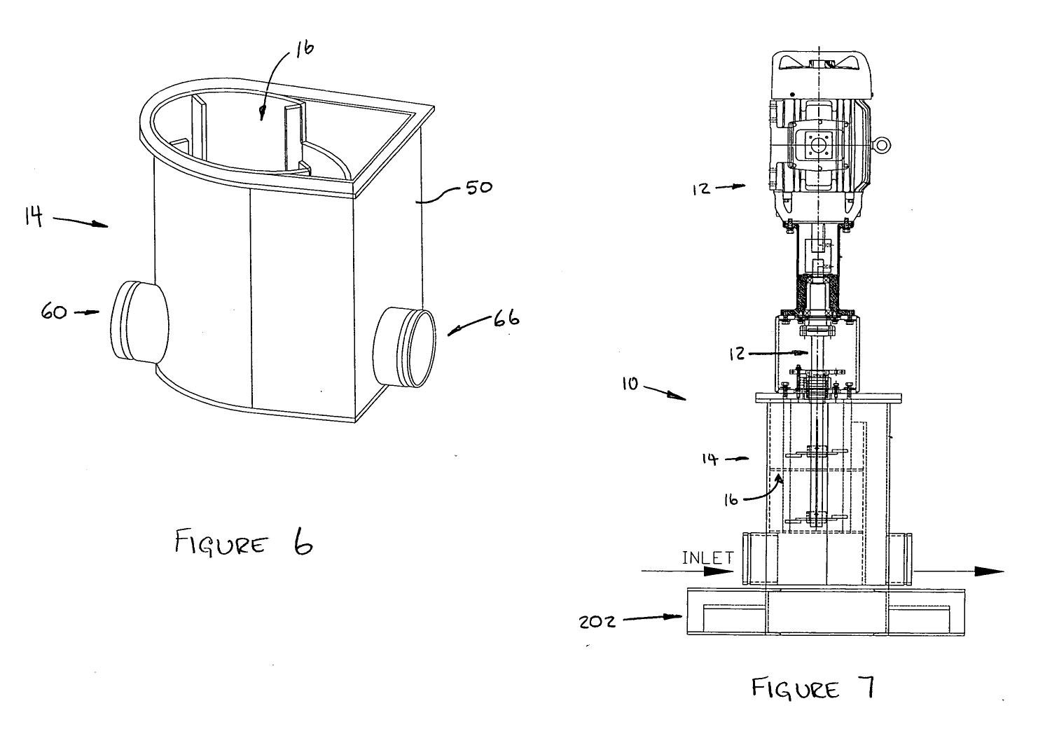

In the embodiment shown, the housing has approximate dimensions of 11″×16″×24″. Of course, the invention is not limited to such a configuration. For example, and as is shown in FIG. 5, the housing may comprise a cylindrical configuration. In the embodiment shown in FIG. 6, a cylindrical and square hybrid housing is provided. In other embodiments, the housing may have other shapes, such as cylindrical, square, elliptical, among others. It is further contemplated that the cross-sectional configuration of the housing can be varied along any one of the width, height and depth.

Inlet 60 is shown in FIG. 2 extending through end wall 51 proximate bottom wall 58. In the embodiment shown, inlet 60 comprises a substantially circular inlet opening 61 having a diameter which is suitable for coupling with standard and conventionally sized piping. Additionally, inlet screens are contemplated for use, to preclude the passage of undesirable materials, or undesirably sized materials. Various clamps and couplings can be utilized to couple inlet 60 with existing plumbing. It is contemplated that the inlet could be positioned in a side wall as well. In another embodiment, inlet 60 may be positioned within the bottom wall. Multiple inlet openings are contemplated as embodiments wherein the inlet is positioned at the top of the housing.

Outlet 62 is shown in FIGS. 1, 2 and 3 as comprising exhaust chamber 64 and outlet opening 66. Exhaust chamber 64 is defined by the opposing side walls 53, 54, the end wall 52 and wall 65 which extends between opposing side walls 53, 54 spaced apart from end wall 52 (and substantially parallel thereto). Wall 65 extends from the bottom wall but stops short of top wall so as to define upper passageway 67 (FIGS. 1 and 2). Outlet 66 comprises a substantially circular member positioned through end wall 52 proximate bottom wall 58. Outlet opening 66 can be coupled to remaining piping utilizing conventional couplings and clamps. Advantageously, the inlet and the outlet opening 66 are substantially collinear, such that the mixer apparatus can be inserted into an existing line without requiring substantial hardware and re-plumbing.

It is likewise contemplated that in place of the exhaust chamber, an outlet opening can be positioned proximate the top wall in any one of the opposing sidewalls and the end walls, or within the top wall itself. In such a configuration, wall 65 can be eliminated which can decrease the size of the housing. In other embodiments, the outlet may be positioned proximate the bottom of the housing. Finally, multiple outlets are contemplated for use.

Orifice assembly 16 is shown in FIG. 2 as comprising first orifice 68, second orifice 70 and baffle member 72. With reference to FIG. 4, first orifice 68 comprises a plate having top surface 73, bottom surface 75. The size of the first orifice is related to the first impeller such that it is between 50% and 135% of the diameter of the first impeller. The optimum orifice to impeller diameter ratio is a function of turnover and residence time of the material therewithin. Furthermore, the first orifice is further sized relative to the second impeller so as to facilitate the passage of the second impeller through the first orifice so that the impellers can be placed properly within housing 50 after the placement of the orifice assembly.

With reference to FIG. 4, second orifice 70 comprises a plate having top surface 77 and bottom surface 79. The second orifice is spaced apart from the first orifice a predetermined distance. The second orifice is related to the second impeller such that it is between 50% and 130% of the diameter of the second impeller. The first and second orifices are substantially parallel to each other and substantially parallel with top wall 56 and bottom wall 58. Of course, the invention is not limited thereto.

To facilitate proper mixing, and to provide a framework upon which to achieve the proper positioning of the two orifices within the housing baffle member 72 is provided. Referring again to FIG. 2, frame 72 includes struts 80, 82, 84 and 86. The baffle members extend toward the impellers in an inward direction and provide obstacles to the circulation of flow within the housing. In turn, the baffles facilitate mixing and preclude the formation of strong circumferential currents within the housing (i.e., preclude the formation of a votex). Furthermore, the two orifices are each attached to the struts such that the frame and the orifices become a single integrated component which can be inserted into the mixing chamber assembly. The baffle member, when inserted extends from the bottom wall 58 to the top wall 56 and precludes vertical movement of the orifice assembly within the housing. Furthermore, the positioning of the baffle members, and the configuration of the orifices likewise precludes movement in other directions. While the baffle members are shown to be substantially elongated members having a substantially rectangular configuration, other configurations are likewise contemplated.

As is shown in FIG. 4, the two orifice divide the mixing chamber into three distinct regions, namely a first region between the first orifice 68 and top wall 56, a second region between second orifice 70 and first orifice 68 and a third region between bottom wall 58 and second orifice 70. The third region has a height substantially equivalent to the diameter of the inlet. The second region and the first region are substantially identical in height such that the two regions bisect the volume above the third region. Of course, the relative sizes of the various chambers can be altered within the scope of the present invention. In other embodiments, such as the embodiment shown in FIG. 5, the third region can be eliminated.

To assemble the mixing apparatus of the present invention, the mixing chamber is first provided. Inlet 60 and outlet 62 can be coupled to existing piping such that the passage of fluid from the inlet will be directed through the mixing assembly and eventually through the outlet. As set forth above, the invention is not limited to any particular manner of coupling the inlet and the outlet to existing equipment.

With the top wall 56 removed, the inside of the mixing housing is accessible. As is shown in FIG. 2, orifice assembly 16 is inserted into the housing such that the second orifice is spaced apart from the bottom wall. Inasmuch as the orifices have a configuration that matches that of the housing, frame 72 insures the proper special positioning of the orifice assembly vis-à-vis the housing of the mixing chamber assembly.

Next, it is necessary to introduce the mixing agitation assembly to the mixing chamber assembly. In particular, a portion of the drive shaft, the impellers and a portion of the motor assembly is attached to top wall 56. The impellers are carefully manipulated such that the second impeller 26 passes through first orifice 68 into a position between the first and second orifices.

Once the second impeller is positioned between the two orifices, top wall 56 is secured. Specifically, the top wall is secured to the remainder of the housing through the use of fasteners such as nuts and bolts. As set forth above, to facilitate portability of the device, handles can be provided in a spaced apart orientation about the top wall. The same nuts and bolts can be utilized to couple the handle to the mixing chamber that are utilized to attach the top wall to the side wall and the front and back wall. In another embodiment, as is shown in FIG. 7, a pallet 202 may be combined with the pump housing. The pallet enhances stability of the entire assembly and greatly enhances the portability and movability of the entire unit.

Once the top wall 56 is positioned and secured, motor assembly 20 can be attached to the mixing chamber assembly. When fully assembled, the mixer apparatus is ready for utilization.

In operation, a material is provided at a particular flow rate through inlet 60. In the embodiment contemplated, the material comprises a mixture of various solids in a working fluid (for example, water or diesel fuel) which together form what is commonly referred to as mud used in association with oil well drilling. The initial introduction of the solids with the working fluid can be accomplished through a number of different means. For example, the solids can be pulled into passing the working fluid through a venturi-type mixing apparatus. Other methods of introduction of the solids is likewise contemplated. Indeed, the invention is not limited to any particular manner in which to provide material to inlet 60.

Once the material enters housing 50 through inlet 60, the material is directed in an upward direction toward and into the third region of the mixing chamber. As additional material enters, the material is driven upward through second orifice 70 and into second impeller 26. As the material passes against and around the second impeller, the solids become dispersed within the working fluid. The material continues through this second region and eventually passes through first orifice 68. At this stage, the material is introduced into first impeller 24 within the first region.

The contact with the first impeller further disperses the solids through the working fluid. As the material continues beyond the first impeller, the material reaches top wall 56 and is directed to the outlet. Specifically, at top wall 56, the material (now thoroughly mixed) is directed through upper passageway 67 into exhaust chamber 64 and finally through outlet opening 66. Unlike the material that was introduced at the inlet, the material at the outlet is thoroughly mixed (i.e., the solids are fully dispersed within the liquid). Such a fine dispersion requires less agitation when directed to a holding tank and typically exhibits substantially greater viscosity.

Certain tests were performed with pump having the configuration disclosed herein. In a first series of tests, an oil based “mud” product was prepared. The “mud” included 2.5 gallons of diesel fuel, 7.5 pounds of MI Barite, 2.7 liters of water, 0.95 liters of CaCl₂, 3 ounces of lime, 3 ounces of VG supreme and 3 ounces of HRP.

A total for four separate tests were performed utilizing the mixture. The first test included a five inch Cowles blade at 2655 fpm for a run time of 60 seconds. The second test included a six inch Cowles blade at 2048 fpm for a run time of 60 seconds. The third test included a five inch Cowles blade at 3186 fpm for a run time of 30 seconds. Finally, the fourth test included a five inch Cowles blade at 3186 fpm for 30 seconds and 3412 fpm for 30 seconds. The results of the tests, expressed as Brookfield Viscosity Readings with #4 spindle, are shown in the table below.

Test No

| RPM | 1 | 2 | 3 | 4 |
|---|---|---|---|---|
| 10 | 960 | 890 | 1580 | 1880 |
| 20 | 550 | 505 | 901 | 1060 |
| 30 | 280 | 260 | 450 | 528 |
| 40 | 172 | 164 | 288 | 318 |

In a second series of tests, a water based “mud” product was prepared. The “mud” included 4 gallons of tap water, 1.5 pounds of MI Gel (Bentonite), 1 ounce lime, 1 ounce caustic and 0.7 ounces xanthium gum for the first test of the second series. In the second, third and fourth tests, an additional 0.5 pounds of MI Gel (Bentonite) was added to the product.

The two tests included a five inch Cowles blade at 2655 fpm for a run time of 55 seconds. The third test included a six inch Cowles blade at 2048 fpm for a run time of 30 seconds. The fourth test included a six inch Cowles blade at 1830 fpm for a run time of 45 seconds. The results of the tests, expressed as Brookfield Viscosity Readings with #4 spindle, are shown in the table below.

Test No

| RPM | 1 | 2 | 3 | 4 |
|---|---|---|---|---|
| 10 | 2000 | 5201 | 3700 | 4560 |
| 20 | 1060 | 2250 | 4580 | 2650 |
| 30 | 472 | 1005 | 2760 | 1480 |
| 40 | 270 | 695 | 1390 | 740 |

With each of the series of tests, it was determined that the mixer of the present invention exhibited superior performance over a conventionally utilized mixer for such products. In particular, whereas such mixtures retain fluid properties when mixed with a conventional mixer for such products, the mixtures achieve a pseudo-plastic configuration with a greatly enhanced viscosity, and a gel-like consistency.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A mixer apparatus comprising:
a mixing chamber assembly having a housing defining a cavity, an inlet providing fluid communication with the cavity and an outlet providing fluid communication with the cavity;
a mixing agitation assembly comprising a motor assembly, a drive shaft coupled to the motor assembly and at least one impeller coupled to the drive shaft, the at least one impeller and at least a portion of the drive shaft positioned within the housing and positioned between the inlet and the outlet; and
an orifice assembly including at least one orifice positioned between the inlet and the at least one impeller,
wherein fluid is directed into the cavity through the inlet and through the at least one orifice, wherein at least a portion of the fluid is mixed by the impeller and exhausted through the outlet.

2. The mixer apparatus of claim 1 wherein the outlet is positioned above the inlet such that fluid directed through the inlet extends in a generally vertically upward direction as it progresses from the inlet, through the at least one orifice, the at least one impeller and the outlet.

3. The mixer apparatus of claim 1 wherein:
the orifice assembly further comprises a first orifice and a second orifice in a spaced apart configuration within the housing so as to define a first region between the second orifice and the housing and a second region between the first and second orifices;
the at least one impeller comprises a first impeller positioned in the first region and a second impeller positioned in the second region.

4. The mixer apparatus of claim 3 wherein the orifice assembly further comprises a frame coupled to each of the first orifice and the second orifice, the frame removably positionable within the cavity so as to facilitate the positioning of the first and second orifice in a proper special orientation.

5. The mixer apparatus of claim 3 wherein the second orifice is spaced apart from the housing so as to define a third region between the housing and second orifice, opposite the second region.

6. The mixer apparatus of claim 5 wherein the inlet is directed into the third region of the cavity.

7. The mixer apparatus of claim 5 wherein the first and second regions are substantially identical in volume.

8. The mixer apparatus of claim 1 wherein the at least one orifice is substantially circular.

9. The mixer apparatus of claims 1 wherein the drive shaft rotates about an axis that is parallel to the flow of fluid through the mixer.

10. A method of mixing mud suitable for use in oil well drilling applications comprising the steps of:
providing the mud through an inlet;
directing the mud through an orifice;
mixing the mud with an impeller;
directing the mud through a second orifice;
mixing the mud with a second impeller; and
directing the mud through an outlet.
